(19) United States
(12) Patent Application Publication
(10) Pub. No.: US 2025/0131934 A1
(43) Pub. Date: Apr. 24, 2025

(54) AUDIO GENERATION SYSTEM AND METHOD

(71) Applicant: Sony Interactive Entertainment Inc., Tokyo (JP)

(72) Inventors: Pierluigi Vito Amadori, London (GB); Maria Pilataki Manika, London (GB)

(73) Assignee: Sony Interactive Entertainment Inc., Tokyo (JP)

(21) Appl. No.: 18/911,317

(22) Filed: Oct. 10, 2024

(30) Foreign Application Priority Data
Oct. 19, 2023 (GB) 2316009.6

(51) Int. Cl. G10L 21/013; G10L 15/18; G10L 25/18

(52) U.S. Cl. CPC G10L 21/013; G10L 15/1815; G10L 25/18; G10L 2021/0135

(57) ABSTRACT

An audio generation system for generating output audio comprising speech, the system comprising an input unit configured to receive a first input defining the semantic content of the output audio, and a second input defining one or more desired characteristics of the output audio, a parameter identification unit configured to identify, from one or more latent spaces each associated with one or more possible characteristics of the output audio, one or more parameters for use in generating the output audio in dependence upon the second input, and an output generating unit configured to generate output audio in dependence upon the first input and the identified one or more parameters.

### BACKGROUND OF THE INVENTION

### Field of the Invention

This disclosure relates to an audio generation system and method.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

When generating content, such as video games or movies, a significant amount of time and effort may be put into the generation of spoken audio content—this can include ensuring that an actor's lines are recited in the desired manner (such as capturing the correct emotion), for example, or obtaining voice-over content that matches an animated character's appearance. This can be very time-consuming in many cases, as if not done correctly poor voice work can have a significant negative impact on the content.

This investment of time and effort can be magnified when localisation of content is considered—as a part of the localisation process the voice content may be required to be translated into a number of different languages or dialects. Another factor which can contribute to high costs is that of more immersive and/or open-world content—these can each be associated with a larger range of voice lines being required (to reduce repetition, for instance, or to fully populate a larger interactive environment), even if they are not all encountered by a user.

It is therefore considered that a method of streamlining the voice generation and/or modification process would be advantageous.

Other aspects of generating/modifying voice outputs can also benefit from such streamlining—for instance, real-time applications such as live voice modification or translation, or text-to-speech applications. In each of these cases a more streamlined process can reduce the reliance on pre-generated content, enabling a more personalised and customisable user experience as a result.

It is in the context of the above discussion that the present disclosure arises.

### SUMMARY OF THE INVENTION

This disclosure is defined by claim 1. Further respective aspects and features of the disclosure are defined in the appended claims.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment system;

FIG. 2 schematically illustrates a voice generation or modification method;

FIG. 3 schematically illustrates an exemplary latent space;

FIG. 4 schematically illustrates an audio generation system; and

FIG. 5 schematically illustrates an audio generation method.

### DESCRIPTION OF THE EMBODIMENTS

Referring now to the drawings, wherein like reference numerals designate identical or corresponding parts throughout the several views, embodiments of the present disclosure are described.

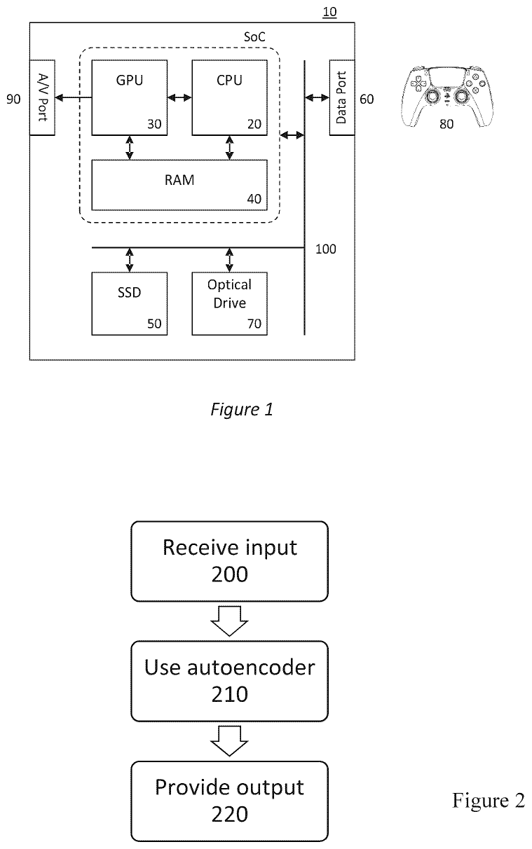

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

This entertainment system is an example of processing hardware that may be configured to implement one or more of the processes described within this document.

Implementations in accordance with the present disclosure, the methods and techniques herein may at least partly be implemented using an autoencoder.

An autoencoder is a type of an unsupervised machine learning model that uses one or more artificial neural networks to learn an efficient representation of unlabelled input data. The autoencoder may be used to encode various types of data, such as images, video, text, or audio.

The autoencoder may comprise an encoder neural network that encodes input data into a reduced representation (also called a “latent space”), and a decoder neural network that aims to recreate the input data from the encoded reduced representation. The latent space is typically of a lower-dimension than the input data-thus, the latent space generated by the encoder typically provides a more efficient, compressed representation of the input data that requires less memory storage than the original input data. In some cases, rather than recreating the input data a decoder neural network may be configured to utilise the information contained within the latent space to generate a new output which is distinct from the input data.

The encoder neural network may comprise one or more layers that transform input data into a reduced representation. The encoder neural network receives input data, and the final layer of the encoder neural network outputs a reduced representation of the input data, the latent space (also termed a “bottleneck layer”).

The decoder neural network may comprise one or more layers that transform data from the latent space into output data of the same dimensionality as the data input to the encoder. The decoder aims, in some cases, to reconstruct the data originally input to the encoder neural network from the latent space representation of the data.

The encoder and/or decoder neural networks typically comprise a plurality of hidden layers. For example, an encoder may comprise a plurality of hidden layers that progressively extract further reduced representations of the input data. Using deeper neural networks (i.e. with a higher number of hidden layers) for the encoder and/or the decoder may improve performance of the autoencoder, and in some cases may reduce the amount of training data that is required.

The encoder and decoder neural networks are typically trained together. During training the autoencoder may adjust its internal parameters (e.g. weights and biases of the encoder and decoder neural networks) so as to optimize (e.g. minimize) a loss/error function, aiming to minimize discrepancy between the data input to the encoder and the output reconstructed data generated by the decoder. It will be appreciated that the specific loss function, and algorithm used to optimize the function may vary depending on the nature of the autoencoder model, and its intended application. In an example, a mean squared error loss function optimized using gradient descent may be used. In some cases, a sparse autoencoder may be used in order to promote sparsity of the latent representation (as compared to the input) and to prevent the autoencoder from learning the identity function—for example, a sparse autoencoder may be implemented by modifying the loss function to include a sparsity regularization penalty.

In some cases, the autoencoder may be a Variational Autoencoder (VAE). The VAE is a specific type of auto-encoder in which a probability model is imposed on the encoded representation by the training process (in that deviations from the probability model are penalised by the training process). The VAE may be used for generative artificial intelligence applications to generate new output data which exhibits similar characteristics to the input encoded data by sampling from the learned latent space.

FIG. 2 schematically illustrates a method for generating an output using an autoencoder in accordance with implementations of the present disclosure.

A step 200 comprises receiving an input; this may be in any suitable format, such as audio, images, text, and/or a set of parameters indicative of properties of a desired output. In some implementations, the input may be converted from the original format into a format that is more suitable for use with the autoencoder—for instance, converting input audio into text, or parametrising an image of a spectrogram.

A step 210 comprises using the autoencoder and the latent space that is generated for a particular application; more specific details regarding the implementation of an autoencoder are described below. In general terms, this step comprises the provision of an input to the autoencoder and the obtaining of an output. This output may be audio that is able to be utilised directly, and/or may include information in any suitable format (such as images, text, and/or a set of parameters) which is able to be used to generate audio.

A step 220 comprises providing the output for use; this can be for immediate output via a loudspeaker or the like, for example, or the output may be stored for later use. For instance, during playing of a game suitable voice outputs may be generated on-the-fly such that the outputs can be generated as required in response to a particular event or the like within the content; alternatively, or in addition, voice outputs may be generated in advance and stored in association with a particular in-game entity so as to be available for use in response to a particular event or the like. Of course, such a process is not limited to these examples and the output may be generated in any suitable context.

Implementations in accordance with this method, examples of which are discussed in more detail below, may be advantageous in a number of cases. Such a method offers an efficient generation of voice content which can have a more realistic quality (such as improved representation of emotions) due to the improved utilisation of sample data. This can also be applied to voice masking, so as to protect the privacy of users, rather than being limited to text-to-speech implementations or the like. Other specific problems that can be addressed by implementations in accordance with this method include improved localisation for content (through generation of voice that is more consistent with a particular location), content customisation, and real-time translation with an audio output.

As noted above, the autoencoder utilises a latent space as a representation of input data. A latent space representation in this case may be generated by parameterising a plurality of sample voices; the choice of parameterisation and selection of sample voices may be made freely by the skilled person in dependence upon the application for which the voice generation/modification is to be used.

In one example, a single user's voice may be sampled in a range of different emotional states. For instance, a user may be requested to provide samples (or have samples otherwise obtained, such as by monitoring voice communications) of a reference phrase being uttered with different emotional qualities. An example of this is a user being asked to state “this is my voice” when experiencing (or at least pretending to experience) different emotions. This may be prompted in response to in-game events or the like, which may be used to predict a likely user emotion (such as a user being happy immediately after scoring a goal in a game).

Based upon this input, a latent space can be generated which comprises representations or parameterisations of the user's voice with different emotions—for instance, by having ‘happy’ and ‘sad’ in the latent space at particular locations, each being associated with qualities (such as pitch and/or volume) which are characteristic of that emotion. This latent space could then be sampled at the midpoint between ‘happy’ and ‘sad’ to obtain voice characteristics which are expected to represent neutral emotion (that is, equal parts happy and sad). Of course, this is a simplified discussion for the sake of clarity—the range and combinations/interpolations of emotions may be considered much more fully in practice.

Rather than being limited to a single reference phrase, it is also possible that the characteristics of each emotion can be extracted from samples of any phrases with a known emotion. While such an analysis may be more challenging (as the samples may be more difficult to compare, due to the different phrases), it may provide a more accurate representation of the user's emotional qualities when speaking and as such can generate useful results.

While the above example relates to the sampling of a single voice for a range of emotions, in some cases it may be considered appropriate to generate latent spaces using a different dataset. For example, in some cases a range of voices (that is, samples obtained from a plurality of users) may be sampled to generate a range of information relating to each emotion. Similarly, one or a plurality of users may be used to obtain samples for a single emotion—in which case the latent space is associated with that specific emotion (and as such a number of such latent spaces should be generated corresponding to different emotions to represent a spectrum of emotion). This may be advantageous in generating ‘an angry voice’ (for instance) in which the latent space is sampled on the basis of characteristics of the person who is angry (such as physical characteristics, and/or voice characteristics). Of course, reference to emotions here is purely exemplary—any other characteristic quantity or quality of a voice (or at least associated with a voice) may be considered appropriate.

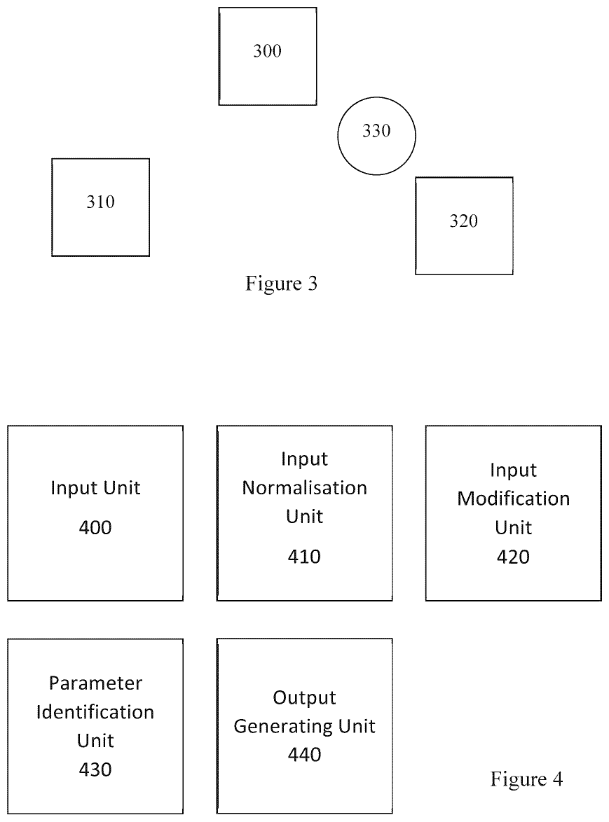

FIG. 3 schematically illustrates a latent space which is populated by three parameterised qualities or quantities, represented by the boxes 300, 310, and 320. The circle 330 represents an intermediate sampling point which is used to generate an output by the autoencoder. The parameterised quantities/qualities may be any suitable variables which may be associated with a particular voice; for instance, emotions (as an example, 300 may be ‘happy’, 310 ‘sad’, and 320 ‘angry’), ages (300 may be ‘20-30’, 310 ‘40-50’, and 320 ‘child’, for example), nationalities, dialects, physical characteristics (such as height), or any other quantity or quality which can be related to voice characteristics.

In some cases the parameterisation may comprise parameters for generation of new voice content—such as volume, pitch, and speed. These parameters, as obtained from the latent space, can then be used in conjunction with a model or library which indicates the pronunciation of words (such as a dictionary with entries for each term comprising International Phonetic Alphabet entries or other pronunciation information) to generate output voice content.

Alternatively, the parameterisation may comprise parameters for the modification of existing voice content, which can be a user's own voice, a stored voice output, and/or a reference voice output which is used as the basis for the generation of voice content. The parameters in this case may be any suitable parameters for being used to define or modify a filter that can be applied to the input voice content to obtain a desired output.

In the case that modifications are applied to input voice content, it may be considered advantageous to first apply a filter or the like to the input voice content so as to generate ‘neutralised’ content; that is, content which has reduced or entirely removed characteristics specific to the user providing the input voice content. For instance, reducing the impact of the user's current emotion upon the input voice content, softening an accent, or varying the characteristic frequencies. This may aid the generation of a suitable output audio in that the filters being applied are able to be applied in a more consistent manner—and as such characteristics of the input voice content and the filters are less likely to interact so as to cause unintended consequences (such as unrealistic speech, or the intended characteristics being obscured). Of course, in some cases it may be instead considered advantageous to identify the words in the input voice content and use this to generate representative audio using a predefined voice generation—this representative audio (effectively, a replacement for the input voice content which comprises the same semantic content) can then be used as the basis for the modification.

Rather than parameters being stored directly, in some examples information may be stored in the form of spectrograms from which information can be obtained about the desired output. The spectrograms may be stored in any suitable format, such as images representing a plot of the signal (frequency versus time, for instance) or a heatmap representing the signal. Due to the different storage format, alternative approaches to the training can be adopted—for instance, using computer vision models such as Convolutional Neural Networks or Vision Transformers. Spectrograms may be generated in any suitable manner; one example is that of using Fast Fourier Transforms to characterise the audio signal by its individual components.

Implementations of the present disclosure may use a number of different latent spaces so as to enable a more tailored approach to voice generation/modification. For example, rather than a general latent space which represents all users a first space may be generated for ‘children’ and a second for ‘adults’; however, spaces may be generated on the basis of any demographic or voice characteristic. Based upon a user's profile information, response to questioning, and/or testing (such as analysing a requested voice input sample provided by the user), a user can be associated with a particular latent space. In some cases, testing (that is, a process by which characteristics of the user's voice are compared to characteristics associated with candidate latent spaces) may indicate that a user should be associated with a group contrary to their demographic information—for instance, an adult with a child-like voice could be associated with a ‘child’ latent space representation to improve accuracy.

In some cases, latent spaces may be provided in a tiered or otherwise inter-related manner to enable a group of appropriate latent spaces to be associated with a particular user or entity. For instance, latent spaces may be provided for a general ‘male’ and ‘female’ voice, with more specific spaces for particular emotions or effects. For instance, a more generic ‘male’ latent space may be used as standard for generating a male voice, with a separate (but linked) respective latent space for ‘tired male’ and for ‘energetic male’ which can be used when particular conditions are met (that is, that the character/user is identified as being tired or energetic—with the ‘male’ latent space being used in all other cases). In some cases, the related latent spaces may be based upon filter information that can be applied to the main latent space outputs rather than entirely new voice generation information. The latent space to be used may be based upon any characteristics of the user (such as biometric data or user inputs to identify mood), or upon the content itself (such as detecting keywords associated with different moods), for example.

As discussed above, implementations in accordance with the present disclosure may be advantageous in a number of different use cases.

A first use case is that of text-to-speech arrangements. In these cases, the inputs include text and one or more indications of characteristics of the desired voice output—these may be explicit, or may be derived from the text itself (for instance, through identifying keywords to determine a suitable representative emotion). This can lead to an improved quality of the voice output, as the use of the latent spaces to generate voice generation parameters can lead to a richer and more varied voice output without a significant burden in creating and storing data representing individual voice samples that can be combined to generate the voice.

A second use case is that of the generation of speech for game characters or the like—this use case is similar to that of text-to-speech, in that a script is typically used to represent a character's lines. Characteristics of the desired voice output may be identified on the basis of information about the character for whom the voice is generated, and/or in response to environmental conditions or actions being taken in the environment of the character. This can enable a more efficient generation of voice outputs, as well as a more efficient storage of the information—rather than storing individual lines for each character, any overlap or redundancy between them can be eliminated by generating the voice on-the-fly. This can also be implemented with speech-to-speech, for instance if reference lines are stored as voice samples which can then be spoken by a number of different characters subject to modification using methods such as those disclosed.

Another use case is that of localisation; this can be performed in a text-to-speech or a speech-to-speech manner. Localisation here refers to generating or modifying content so as to more closely align with that expected in a particular region—for instance, emphasising different sounds within words, or expressing emotions in different ways through speech. This can be achieved by using latent spaces which are specific to particular regions, nationalities, and/or dialects, and as such the latent spaces reflect the characteristic features of those. This may be combined with a pre-processing of the input content so as to perform a translation into a different language, or a modification so as to align more closely with normal speech in that region—such as adding or removing slang terms or the like.

User privacy may also be an area in which such arrangements may be advantageous; such arrangements may offer users an efficient and effective manner of disguising or masking their identity by modifying their voice. For instance, a user may wish to adopt a more neutral voice to disguise their nationality, gender, or emotions. While basic voice modifiers have been used for such purposes previously, a more nuanced and natural voice output may be generated using methods disclosed in the present document without a significant processing burden.

FIG. 4 schematically illustrates an audio generation system for generating output audio comprising speech, the system comprising an input unit 400, an optional input normalisation unit 410, an optional input modification unit 420, a parameter identification unit 430, and an output generating unit 440.

The input unit 400 is configured to receive a first input defining the semantic content of the output audio, and a second input defining one or more desired characteristics of the output audio. While indicated as separate inputs here, the first and second inputs may be related (for instance, with the second input being metadata associated with the first input) so as to be provided together. Similarly, the second input may comprise information that is obtained from the first input—such as analysing the first input for commands (for example, speech or text indicating a desired characteristic) or context which indicates a desired characteristic (such as identifying whether the first input is largely positive or negative based upon keywords or context, and identifying a corresponding emotion for the output audio as a desired characteristic). In the latter case, a natural language model or the like may be used to identify a mood or meaning associated with the first input.

In other words, it may be considered in some implementations that the first and second input can be provided in combination, or that the input unit may be configured to process the first input in order to obtain the second input.

The first input may comprise text and/or audio comprising speech which defines the semantic content—for instance, a script or sample text may be used as the basis of the audio generation. Similarly, pictograms, images, or video may be used as a prompt or to otherwise communicate the content of the output audio (such as requesting that a particular image be described, which is functionality that may be realised by implementations of the present disclosure which are provided in combination with an image recognition/analysis model). In the case that the first input comprises audio, it may be considered advantageous to generate a transcript of the audio and use this as the first input in embodiments in which it is preferred that the first input is a text input (for instance, in a process which comprises audio generation rather than audio modification—or in which the first input is of too low a quality to generate a suitable audio output).

The desired characteristics may include any characteristics of a voice that can cause it to be distinguished from another voice; while in some cases these may simply be descriptive of the audio that is desired (such as ‘high-pitched’ or ‘loud’), in a number of cases it may be advantageous to refer to characteristics of a speaker associated with the output audio. For instance, this could include any one or more of: (i) an emotion of a speaker associated with the output audio; (ii) an age of a speaker associated with the output audio; (iii) a gender of a speaker associated with the output audio; (iv) a nationality of a speaker associated with the output audio; and/or (v) an accent of a speaker associated with the output audio.

In each case, it is understood that there is no human speaker associated with the output audio (or at least only indirectly, in that a human speaker may be associated with the input audio) as the output audio is generated for output by a device. It can therefore be considered that the speaker referred to here is a virtual speaker, such as a character in a game, or a fictional speaker that is referred to for ease of implementation. In other words, the output audio can be associated with a number of different characteristics (such as a particular age and nationality) which are attributed to this ‘speaker’ rather than to the audio directly.

A desired characteristic is considered to be desired in that it may be specified by a user who specifies a particular characteristic for the output to have; alternatively, or in addition, characteristics may be considered to be desired in that they would represent a realistic presentation of the output audio—such as reflecting a suitable emotion, or the like. In other words, the term ‘desired’ may reflect the wishes of a particular user and/or a suitability for the output audio.

The input normalisation unit 410 is configured to apply a normalisation process to the first input; a normalisation process here refers to the generation of ‘neutralised’ content as discussed above. In other words, this is processing which is considered to convert the first input into a more standardised form which may be more appropriate for the application of additional processing. For instance, this may include a volume levelling, or a conversion of input audio so as to compress the frequency range-alternatively, processing may be performed so as to account for characteristics of the source of the first input such as removing indicators of a speaker's age. While discussed in the context of audio processing here, this normalisation may include the adaptation of written text or the like, such as to replace obscure (or unknown) words with more typical words, remove slang terms, or otherwise change the text so as to reflect fewer characteristics of the source of the text (such as a script writer).

The input modification unit 420 is configured to modify one or more aspects of the first input so as to substitute one or more words or phrases represented by the first input with alternatives; this may be performed in dependence upon the second input. While a similar process may be performed as a part of the normalisation described above, the input modification unit 420 is instead configured to adapt the first input so as to more closely reflect characteristics of the desired output. For example, if the first input comprised the phrase “I am happy” and the second input indicated that this should be spoken with a mood of “angry” then this presents a clear mismatch—in this case, the first input may be modified to instead comprise the phrase “I am angry”. This is a simplified example to illustrate the concept, but it should be appreciated that any such substitution may be performed for the purpose of aligning the first and second input more closely.

Such a modification may be implemented using a natural language model or the like to determine the sentiment of the first input or a portion of the first input to enable a comparison with that indicated by the second input. In some cases, it may be sufficient that a keyword analysis is performed so as to identify an overall sentiment. In either case, a corresponding process may be used to identify suitable replacements—for instance, identifying emotive keywords and substituting them using an available dictionary or the like, or using a natural language model that is trained to modify the sentiment of the first input by substituting, adding, or removing words.

The parameter identification unit 430 is configured to identify, from one or more latent spaces each associated with one or more possible characteristics of the output audio, one or more parameters for use in generating the output audio in dependence upon the second input. These parameters may comprise variables for use in generating audio, or parameters (such as transformations) for use in modifying existing audio, for example.

In some cases, the parameter identification unit 430 may be configured to select one or more latent spaces from which to identify parameters in dependence upon the first input and/or the second input—however, this may be omitted in the case in which latent spaces are selected based upon user input or the like, or in which only a single latent space is available. In such cases, it is considered only that latent space position from which parameters are obtained is defined by the first and/or second inputs.

Latent spaces may be considered to be associated with possible characteristics in that the latent spaces may be labelled with one or more corresponding characteristics, or some other correspondence is indicated. For example, a latent space may be labelled ‘angry man’, or be tagged with ‘angry’ and ‘man’ labels—in other words, one or more labels may be attributed to each of the latent spaces. These can enable the latent space to be identified during the audio generation process as being associated with these corresponding characteristics by mapping the desired characteristics to these labels.

The dependence upon the second input may be realised in any suitable manner for a given second input; different formats of input of course utilise the information within the input in a different manner. In effect, the second input is used to define a modifier for the first input, or a number of constraints for the generation of audio representing the first input.

For instance, in the case that the second input is text indicating particular characteristics it may be required that these are processed in order to identify known tags that are associated with latent spaces. For example, if the second input indicates that a character is ‘raging’ then processing may be performed to determine that this relates to the label ‘angry’, which enables the correct latent space to be identified. In the case that the second input comprises audio or video (either real, or content from a game or the like) which indicates one or more characteristics to be mimicked, audio/video processing may be performed to extract those characteristics. For example, analysing body language to determine a mood may be performed in the case of a video input.

In some implementations, the one or more latent spaces (or at least one of the latent spaces) may be configured in a hierarchical manner, such that a latent space lower in the hierarchy represents a subset of the characteristics of a latent space higher in the hierarchy. For instance, a top level of the hierarchy may be general latent spaces corresponding to each gender, or a plurality of age ranges; lower levels may then comprise latent spaces which are specialised towards different characteristics. For instance, a general ‘positive’ or ‘negative’ latent space may be defined for each, with specific emotions being represented at lower levels in the hierarchy as appropriate.

This may be advantageous in that more specialised latent spaces may lead to improved audio generation—but in many cases a more general latent space may be sufficient, such as in the case that a latent space traversal is undesirable or in which no strong emotion (or other characteristic) is represented. Examples of when a traversal would be undesirable include when using a device having limited processing power or audio reproduction capabilities (such that differences in the output audio may be less noticeable to a listener), or in which a device with limited storage is provided with only a part of the hierarchy to reduce storage requirements.

Of course, rather than a hierarchy it may be considered appropriate that a single large latent space is provided covering all possible characteristics, or that a number of large latent spaces are provided on a general basis—such as a ‘male’ latent space which covers all possible emotions, but is limited only to male voices.

Once a latent space has been selected using any suitable process, a position within the selected latent space is identified from which to obtain parameters. In some cases this may be random—this may add variety to the audio generation process, as well as make it more efficient due to not being required to identify locations via specific processing. However, in other cases it may be defined based upon the first and/or second inputs which can be used to specify further characteristics. For instance, the ‘angry man’ latent space may comprise parameters generated on the basis of a range of men of differing ages and sizes—and so a location may be selected within this latent space may be selected on the basis of age and/or size information determined from the first and/or second inputs (or indeed, additional inputs such as those provided by a user or a character profile for use in generating the output audio).

In some cases, a position may be identified on the basis of user inputs, or based upon consistency through the generation process (such that a position may be selected for a first generation process, randomly or otherwise, and then the same position is utilised for each of the additional audio generations performed at later times). In the case of a consistent position being selected, processing may be performed so as to account for differing latent space sizes or the like—such as a coordinate conversion to maintain a position relative to the centre and boundaries of the latent space, or the like.

The one or more latent spaces may be generated using spectrograms of voice samples; these latent spaces would therefore comprise spectrograms, or parameters defining spectrograms, which can be used for the generation of the output audio. In many cases however it is considered that a number of parameters which can be used as an input to a voice generation process are defined in the latent space, or parameters which can be used to define a filter to be applied in a voice modification or generation process.

The output generating unit 440 is configured to generate output audio in dependence upon the first input and the identified one or more parameters. This may comprise the generation of new audio in some implementations, or the modification of existing audio in the case that the first input comprises audio that may be modified. In other words, the output generating unit 440 may be configured to generate new audio to obtain the output audio and/or configured to modify the first input, in the case that the first input is audio comprising speech, to obtain the output audio.

In the case that the first input does comprise audio, the parameters identified by the parameter identification unit 430 may include one or more filters (or parameters which may be used to generate a filter) to be applied to the first input, with the output generating unit 440 being configured to apply these one or more filters to the first input.

In some implementations, a more iterative approach to the generation of the output audio may be considered appropriate; this may be suitable in the case that parameters are obtained from each of a number of latent spaces corresponding to different characteristics (rather than a single latent space corresponding to a plurality of characteristics). In such implementations, the parameter identification unit 430 is configured to identify a plurality of sets of parameters, each from a respective latent space, and the output generating unit 440 is configured to generate output audio in a multi-stage process, in which each stage corresponds to the use of a different one of the plurality of sets of parameters.

This multi-stage process may include the generation of initial audio on the basis of a first set of parameters (or indeed a default set of parameters which are not dependent upon any particular characteristics), with successive filters or modifications being applied to the audio on the basis of the additional sets of parameters. In the case that the initial audio is obtained from the first input, it is considered that the successive modifications may be applied to this directly without the need to generate new audio.

The arrangement of FIG. 4 is an example of a processor (for example, a GPU, TPU, and/or CPU located in a games console or any other computing device) that is operable to generate output audio comprising speech, and in particular is operable to: receive a first input defining the semantic content of the output audio, and a second input defining one or more desired characteristics of the output audio; optionally apply a normalisation process to the first input; optionally modify one or more aspects of the first input so as to substitute one or more words or phrases represented by the first input with alternatives; identify, from one or more latent spaces each associated with one or more possible characteristics of the output audio, one or more parameters for use in generating the output audio in dependence upon the second input; and generate output audio in dependence upon the first input and the identified one or more parameters.

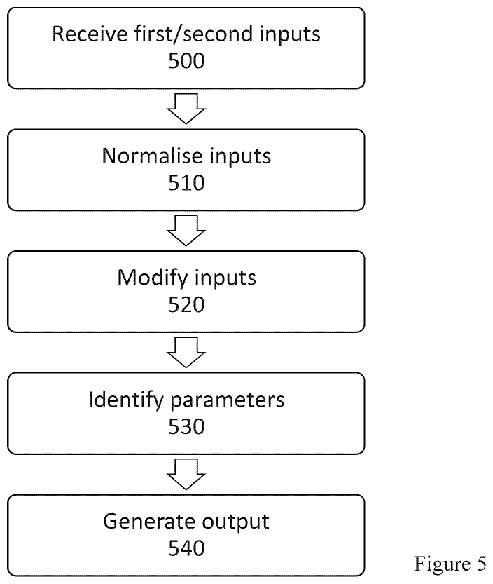

FIG. 5 schematically illustrates an audio generation method for generating output audio comprising speech. Steps of this method may be implemented by the system described with reference to FIG. 4 above, for example.

A step 500 comprises receiving a first input defining the semantic content of the output audio, and a second input defining one or more desired characteristics of the output audio. A step 510 comprises optionally applying a normalisation process to the first input. A step 520 comprises optionally modifying one or more aspects of the first input so as to substitute one or more words or phrases represented by the first input with alternatives. A step 530 comprises identifying, from one or more latent spaces each associated with one or more possible characteristics of the output audio, one or more parameters for use in generating the output audio in dependence upon the second input. A step 540 comprises generating output audio in dependence upon the first input and the identified one or more parameters.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

Embodiments of the present disclosure may be implemented in accordance with any one or more of the following numbered clauses:

1. An audio generation system for generating output audio comprising speech, the system comprising: an input unit configured to receive a first input defining the semantic content of the output audio, and a second input defining one or more desired characteristics of the output audio; a parameter identification unit configured to identify, from one or more latent spaces each associated with one or more possible characteristics of the output audio, one or more parameters for use in generating the output audio in dependence upon the second input; and an output generating unit configured to generate output audio in dependence upon the first input and the identified one or more parameters.
2. A system according to clause 1, wherein the first input comprises text and/or audio comprising speech.
3. A system according to any preceding clause, wherein the desired characteristics include one or more of: (i) an emotion of a speaker associated with the output audio; (ii) an age of a speaker associated with the output audio; (iii) a gender of a speaker associated with the output audio; (iv) a nationality of a speaker associated with the output audio; and/or (v) an accent of a speaker associated with the output audio.
4. A system according to any preceding clause, comprising an input normalisation unit configured to apply a normalisation process to the first input.
5. A system according to any preceding clause, wherein the output generating unit is configured to generate new audio to obtain the output audio and/or configured to modify the first input, in the case that the first input is audio comprising speech, to obtain the output audio.
6. A system according to clause 5, wherein: the parameters comprise one or more filters to be applied to the first input, and the output generating unit is configured to apply the one or more filters to the first input.
7. A system according to any preceding clause, comprising an input modification unit configured to modify one or more aspects of the first input so as to substitute one or more words or phrases represented by the first input with alternatives.
8. A system according to any preceding clause, wherein the one or more latent spaces are configured in a hierarchical manner, such that a latent space lower in the hierarchy represents a subset of the characteristics of a latent space higher in the hierarchy.
9. A system according to any preceding clause, wherein the parameter identification unit is configured to select one or more latent spaces from which to identify parameters in dependence upon the first input and/or the second input.
10. A system according to any preceding clause, wherein the one or more latent spaces are generated using spectrograms of voice samples.
11. A system according to any preceding clause, wherein: the parameter identification unit is configured to identify a plurality of sets of parameters, and the output generating unit is configured to generate output audio in a multi-stage process, in which each stage corresponds to the use of a different one of the plurality of sets of parameters.
12. A system according to any preceding clause, comprising an audio output unit configured to reproduce the generated output audio.
13. An audio generation method for generating output audio comprising speech, the method comprising: receiving a first input defining the semantic content of the output audio, and a second input defining one or more desired characteristics of the output audio; identifying, from one or more latent spaces each associated with one or more possible characteristics of the output audio, one or more parameters for use in generating the output audio in dependence upon the second input; and generating output audio in dependence upon the first input and the identified one or more parameters.
14. Computer software which, when executed by a computer, causes the computer to carry out the method of clause 13.
15. A non-transitory machine-readable storage medium which stores computer software according to clause 14.

1. An audio generation system for generating output audio comprising speech, the system comprising:
an input unit configured to receive a first input defining the semantic content of the output audio, and a second input defining one or more desired characteristics of the output audio;
a parameter identification unit configured to identify, from one or more latent spaces each associated with one or more possible characteristics of the output audio, one or more parameters for use in generating the output audio in dependence upon the second input; and
an output generating unit configured to generate output audio in dependence upon the first input and the identified one or more parameters.

2. The system of claim 1, wherein the first input comprises text and/or audio comprising speech.

3. The system of claim 1, wherein the desired characteristics include one or more of:
i. an emotion of a speaker associated with the output audio;
ii. an age of a speaker associated with the output audio;
iii. a gender of a speaker associated with the output audio;
iv. a nationality of a speaker associated with the output audio; and/or
V. an accent of a speaker associated with the output audio.

4. The system of claim 1, comprising an input normalisation unit configured to apply a normalisation process to the first input.

5. The system of claim 1, wherein the output generating unit is configured to generate new audio to obtain the output audio and/or configured to modify the first input, in the case that the first input is audio comprising speech, to obtain the output audio.

6. The system of claim 5, wherein:
the parameters comprise one or more filters to be applied to the first input, and
the output generating unit is configured to apply the one or more filters to the first input.

7. The system of claim 1, comprising an input modification unit configured to modify one or more aspects of the first input so as to substitute one or more words or phrases represented by the first input with alternatives.

8. The system of claim 1, wherein the one or more latent spaces are configured in a hierarchical manner, such that a latent space lower in the hierarchy represents a subset of the characteristics of a latent space higher in the hierarchy.

9. The system of claim 1, wherein the parameter identification unit is configured to select one or more latent spaces from which to identify parameters in dependence upon the first input and/or the second input.

10. The system of claim 1, wherein the one or more latent spaces are generated using spectrograms of voice samples.

11. The system of claim 1, wherein:
the parameter identification unit is configured to identify a plurality of sets of parameters, and
the output generating unit is configured to generate output audio in a multi-stage process, in which each stage corresponds to the use of a different one of the plurality of sets of parameters.

12. The system of claim 1, comprising an audio output unit configured to reproduce the generated output audio.

13. An audio generation method for generating output audio comprising speech, the method comprising:
receiving a first input defining the semantic content of the output audio, and a second input defining one or more desired characteristics of the output audio;
identifying, from one or more latent spaces each associated with one or more possible characteristics of the output audio, one or more parameters for use in generating the output audio in dependence upon the second input; and
generating output audio in dependence upon the first input and the identified one or more parameters.

14. A non-transitory machine-readable storage medium which stores computer software which, when executed by a computer, causes the computer to perform a method for generating output audio comprising speech, the method comprising:
receiving a first input defining the semantic content of the output audio, and a second input defining one or more desired characteristics of the output audio;
identifying, from one or more latent spaces each associated with one or more possible characteristics of the output audio, one or more parameters for use in generating the output audio in dependence upon the second input; and
generating output audio in dependence upon the first input and the identified one or more parameters.
